(19) United States
(12) Patent Application Publication
(10) Pub. No.: US 2006/0040242 A1
(43) Pub. Date: Feb. 23, 2006

(54) System and method for teaching reading and writing

(75) Inventor: Roberto G. Mejia, San Jose, CA (US)

Correspondence Address: SQUIRE, SANDERS & DEMPSEY L.L.P, 600 HANSEN WAY, PALO ALTO, CA, 94304-1043, US

(73) Assignee: Literacy S.T.A.R., Watsonville, CA (US)

(21) Appl. No.: 11/173,135

(22) Filed: Jul. 1, 2005

Related U.S. Application Data
(63) Continuation-in-part of application No. 10/616,629, filed on Jul. 9, 2003.
(60) Provisional application No. 60/585,480, filed on Jul. 1, 2004.

(51) Int. Cl. G09B 1/00

(52) U.S. Cl. 434/170; 434/167

(57) ABSTRACT

A device for helping a person learn to read and write. The device displays a plurality of character sets, such that the character sets in the proper order spell a word in a given language. Each character set is associated with a unique color relative to the other character sets in the plurality. The device further displays a set of items (e.g., lines or boxes) representing character locations, such that each item is associated with an image representing the sound of one of the character sets and a color matching the color associated with the one of the character sets. The colors associated with the items representing the character locations indicate the order of the character sets to spell the word. The device may be a flashcard, which may be made for use with a dry erase marker. Various learning games can be played that use the device to make learning easy and fun.

### RELATED U.S. APPLICATION DATA

This application claims priority to and incorporates by reference provisional application Ser. No. 60/585,480 and nonprovisional application Ser. No. 10/616,629. This application also incorporates by reference provisional application Ser. No. 60/394,750 and Disclosure Document No. 523,502, filed on Dec. 12, 2002.

### BACKGROUND

1. Field of the Invention

The present invention relates to reading and writing, and specifically relates to a system and method of encoding (writing) and decoding (reading) sounds of a language for the purpose of transferring word meaning/knowledge back and forth between oral and academic text language.

2. Brief Description of the Prior Art

Alphabet blocks have been used as a learning tool, but they teach a phonetic alphabet, while the English language, especially, along with many other languages, is not phonetic. So the lack of definite logic to the sound-letter correspondence is a serious barrier for literacy learning. As a logic or generalization, with most languages, there is no one-to-one correspondence between the symbols used and the sounds they represent. A second essential issue of the problem is that text language and oral language have very different formats and environments. Children learn their first language orally and nearly automatically, but often have great difficulty when it comes to reading and writing for comprehension. Symbols such as visible letters are the immediate “surface” code for text, while invisible sounds are the immediate code for oral language. It would seem logical that sounds should be more difficult to manage since they are invisible while letters are so obvious to observe since they are visible. However, oral language is typically practiced in meaning-rich situations by which meaning can be derived by associating meaningful phenomena to a particular series of sound-coded oral expressions (words). For example, meaning in oral language is communicated not only by speaking, but by factors such as nonverbal communication. A wider avenue for associating comprehension to sound-coded words can come from sources such as the location of a conversation, the relationship between communicators, the time of day, and tone of voice. Oral language can be learned not only by listening but also by observing a wider variety of cues in the environment compared to text language where pictures and a series of letter symbols (such as illustrated books) give oral language little competition.

The standard approach that has been practiced is teaching a brand of phonics that teaches learners that letters make sounds. This approach leads to many overgeneralizations and does not even monopolize on the oral nature of language by putting the cart (letters) before the horse (sounds). Sounds (sound-codes) move meaning in oral language. Sounds are a kind of currency for trading meaning in spoken language. A kind of glue binds meaning to sound code in oral language. So the phonemic (sound) nature of language must be appreciated and accommodated for in all language and literacy learning. Learning beginning with the letter starts off in unfamiliar territory. The letter as the starting point (is often the ending point in the case of failure-like a trap) is supposed to cue to the sound. For new learners, this means that something you don't understand (letters) is supposed to lead you to something that you do understand (sounds). It is much better to go from the known to the unknown in case of a need to retreat back to the familiar to lick wounds and venture forth later. Add to this the inconsistency of the unpredictable sound-letter correspondence and learning to read and write comprehensively is truly an effort. The idea that letters make sounds does not accurately reflect the invention of the alphabet nor does it aid its practice. Sounds existed before the concept of alphabetic letters, since oral language is natural, but literacy (the alphabet) is unnatural as it was invented.

Imagine that long before any visual symbols were ever etched onto the ground or painted onto a tree or stone face, sounded expressions existed as rudimentary forms of language, which eventually evolved into comprehensible and socially practiced and shared vocabulary. So a member of a language group is used to at least hearing but also speaking language in a sound code as a cause that affects a memory recall connecting the sound-coded words to a meaningful association. Thus, when a learner attempts to learn to read and write, the letters make sounds approach is an extremely poor introduction to learning to read and write. This is why many dislike reading and have even less affection for writing. Visual symbols such as the alphabet have no initial association with meaning or the sound code since sound is the main partner for meaning association for a non-literate learner in terms of language. A beginning learner's comprehension starts at zero with non-sound visual letters. Instead of using the strength of ability and familiarity, the reading learner is hindered.

Acquiring reading skill by simply learning to read is an approach that works against the oral nature of language. It can too often be laborious, boring, unrewarding, and detrimental for many learners, since self esteem can drop after repeated attempts followed by repeated failure. The way reading is typically taught involves unfamiliarity, then the reader has to work their way backwards (back to their instinctual listening ear for the sounds of their sound-coded reality), so finally the symbol(s) is associated to the sound. Then, the reader goes to the next symbol in a word then backwards again to search for the sound that was the effect of the letter, then back and forth, etc., kind of like a clumsy saw running back and forth cutting through wood compared to a rotating electric saw that goes in one direction and loses little time and energy. Interestingly, if letters make sounds, why does a learner have to search for that sound?

Developments in this field include Reading Rods® made by ETA Cuisenaire®. These devices are connectible colored rods that have letters, letter patterns, or whole words. These rods are used with illustrated activity cards. An example is, two rods are illustrated next to a picture of a cake. The second rod “ake” is printed on the card while the first rod depicted on the card has no letter on it. Zoophonics® uses a system where an animal (a particular animal is used for it's name based on the initial sound of that name, which is a particular phoneme) is drawn in the shape and vicinity of each of the 26 letters. Read America Inc. has a method called Phono-Graphix®. This method teaches that letters and letter patterns are pictures of sound. Small printed squares contain a letter or letters. These printed squares are combined to form words.

### BRIEF DESCRIPTION OF DRAWINGS

FIG. 1a shows the front side of a Flash Literacy Top 100 Words Flashcard;

FIG. 1b shows the reverse side of the Flashcard of FIG. 1a;

FIG. 2 shows one Sound-Writer Flashcard;

FIG. 3 shows a second Sound-Writer Flashcard;

FIG. 4 shows a third Sound-Writer Flashcard;

FIG. 5 is an activity for use with Sound-Writer Flashcards of FIG. 2-4;

FIG. 6 shows a Literacy Matrix;

FIG. 7 is an activity for use with Literacy Matrix;

FIG. 8 shows a page in the Alphabetized/Teacher version of Academic Bridge Codex;

FIG. 9 shows a page in the Sound-Ordered/Learner version of Academic Bridge Codex;

FIG. 10a shows the front side of three Language and Literacy Coins;

FIG. 10b shows the reverse side of three Language and Literacy Coins of FIG. 10a;

FIG. 10c is an activity useable with Language and Literacy Coins;

FIG. 11a shows front side of three Phonetic Literacy Coins;

FIG. 11b shows reverse side of Phonetic Literacy Coins of FIG. 11a;

FIG. 12 shows a Literacy Code Wheel of English Vowel Sounds and Spellings;

FIG. 13 shows an intuitive indicator for teaching the order of strokes for an orthography activity for writing the entire alphabet in one sentence;

FIG. 14 shows an orthography writing activity for the first two words of “The quick brown fox jumps over the lazy dog.”;

FIG. 15 shows a screen shot of the Blue Tiger Literacy Software program;

FIG. 16 shows a legend for icons representing Parts of Speech used in Blue Tiger, Flashcards and other embodiments;

FIG. 17 shows a page from a “Write it Yourself” book including a writing activity and three connectible Grammatical puzzle pieces;

FIG. 18 shows a Graphophonic Block;

FIG. 19 shows an activity for FIG. 18;

FIG. 20 shows details on How to Use Sound-Pictures in Reading and Writing activities for embodiments of invention;

FIG. 21 shows a Reading and Writing Proprietary Device;

FIG. 22 shows a Phonemic Awareness and Literacy Bingo Game;

FIG. 23 shows instructions for ESCALERA Bingo;

FIG. 24 shows two pages of a Language Learning Book with illustration boxes;

FIG. 25 shows two pages of a Writing Language Book without illustrations boxes; and

FIG. 26 shows a method for simulating conversation.

FIG. 27A-D shows further description of Flash Literacy Cards

### DETAILED DESCRIPTION OF THE DRAWINGS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

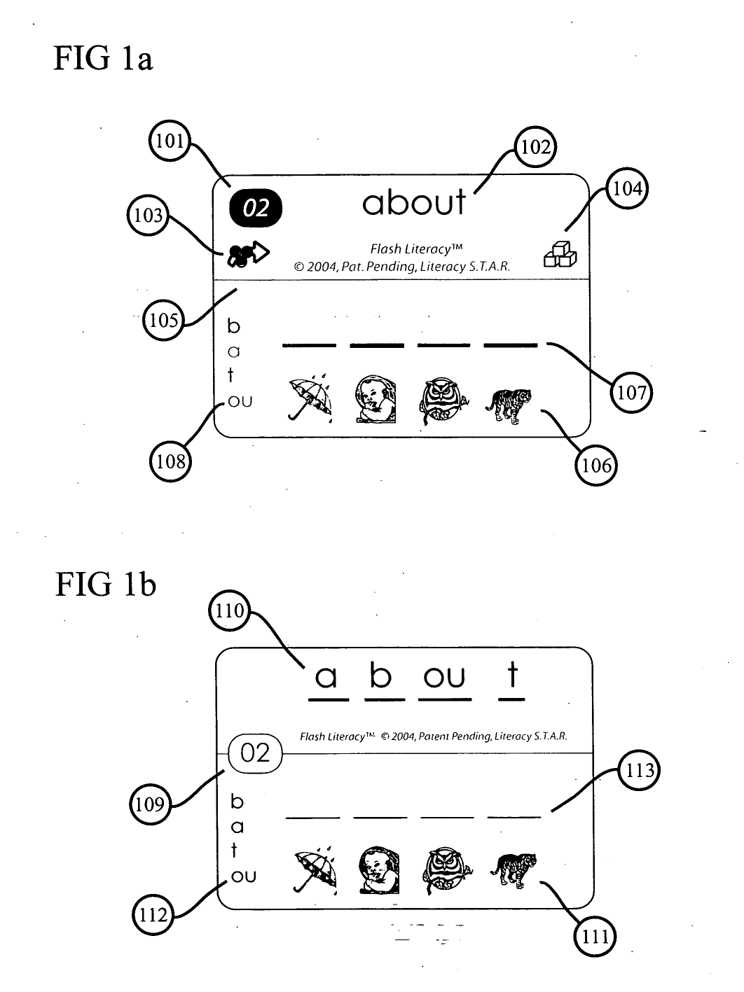

FIG. 1a is the front side of one of the Flash Literacy Top 100 Words Flashcards that may be written on, wiped, and reused in conjunction with a dry erase marker. The colored Flashcard number 101 is used to identify which of the top 100 words the card is. The colored number can be used to indicate which words to collect in preparation for a writing activity and can be also used to quickly sort then reorder flashcards by tens, for example the colored Flashcard numbers of cards 1-10 are colored red to help identify them more quickly than by number alone. The word “about” 102 is displayed as natural text for a learner to be assessed by attempting to read it. Sentences built with these Top 100 naturally displayed text words can be used to assess reading comprehension since many readers can decode multiple words and lose comprehension since they focus too hard on decoding and lose meaning in the process. The writing activity on the bottom of this Card Flashcard with the top covered (writing the word starting from sounds) can assist in learning encoding and decoding ability simultaneously via reversible logic for this word, that is a text word can be more easily read since it was self-written. Icons 103 and 104 represent two part of speech roles (Adverb and Preposition) that this word may take. The bottom half of the card below the gray line 105 may be covered while assessing the reader for reading ability. The second use of the front side of this card as explained earlier is to teach the learner to write the word especially if the learner cannot read it which will reinforce both specific (for this word) and global reading and writing ability (for words that share similar sound-spelling correspondences). The Sound-Pictures 106 such as the tiger representing the sound /t/ are displayed to cue the learner to the sounds that compose the word. Colored spelling lines (grapheme lines) 107 are color matching indicia to show a learner which spellings 108 are associated with which sounds for writing the word “about.” For example, the spelling “t” is colored red as is the spelling line above the /t/ tiger sound colored red. Other spelling lines will likewise match their associated spellings with different matching colors per sound-spelling correspondence.

FIG. 1b shows the reverse side of FIG 1a. This card also has the flashcard number 109 but the number's location is different to indicate that the card is the reverse side of the flashcard of card #02 along with indicating the reverse side's different functions. The top half is an assisted reading assessment activity 110 with each spelling separated and written on its own spelling line to break down the reading code spelling components for a user. The bottom half is an assisted writing assessment activity similar to bottom half of side 1 of Flashcard with the sounds displayed 111 except there is no colored indication as to where each spelling 112 goes to which spelling line 113.

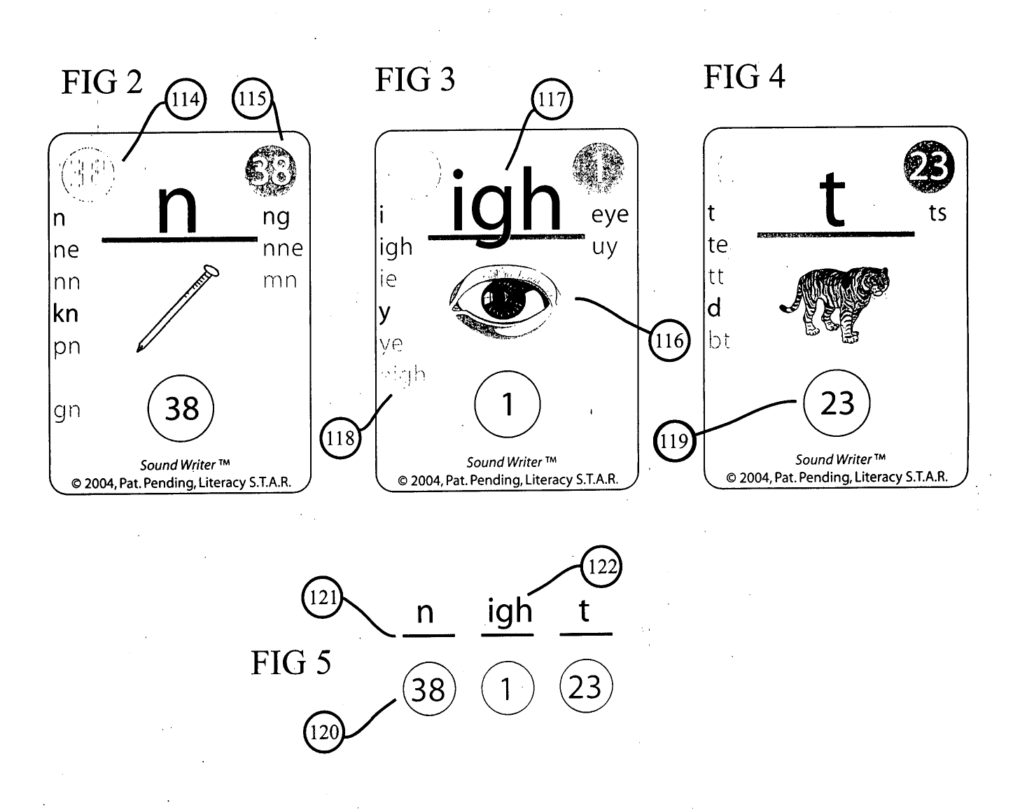

FIG. 2 shows one Sound-Writer Flashcard that may be written on, wiped, and reused in conjunction with a dry erase marker. This flashcard is for the sound /n/. The solid black number “38” represents a card's Sound-Picture number and is helpful in locating and displaying all flashcards like the night, eye, and tiger flashcard 119 to write the word “night”. Each Sound-Picture number, 1-44 as for English for example, identifies a Sound-Picture used to sort, identify, and locate Flashcards for writing activities and for assisted reading of self written words. A writing activity will include colored Sound-Picture Numbers that serve as dual-function indicia to select spellings such as the two alternate spelling columns 114 and 115 by which a spelling is selected from depending on the matching color of the Sound-Picture in a writing activity and the matching color of the spelling in a column on the Flashcard for each sound written in each word. For example, if the spelling “eigh” 118 is colored blue, it would be designated to spell the middle sound of height with a blue colored Sound-Picture number “1” for the “Eye” Sound-Writer Flash-Card while other spellings for the “eye” sound are colored differently. Once again for example, indicia such as a black colored Sound-Picture number 120 would be used learner is to identify both the sound (/n/) and the letter “n” out of the alternate spellings for the sound /n/ and the “eye” sound is spelling “igh” 117 on the writing activity line 122 for the sound 116 represented by the “eye” Sound-Picture.

FIG. 3 shows a second Sound-Writer Flashcard as the middle sound and written spelling of a writing activity already detailed earlier with FIG. 2.

FIG. 4 shows a third Sound-Writer Flashcard with the ending sound and written spelling of a writing activity.

FIG. 5 is an activity for use with Sound-Writer Flashcards explained in FIG. 2-4 where only the spellings are visible so that the end-product writing on the spelling lines may be on a separate surface or separate display and the words may be read without the Sound-Pictures in view to force a learner to recall thus encourage more natural text reading skill. The lines with Sound-Pictures contain the spellings while the Sound-Pictures may be used as aide to assist in sounding out difficult or un-mastered spelling code. The accurate breakdown of spellings and sound correspondences assist a learner towards more independent skill. They learn to both read and write and transition to natural text without spelling lines or Sound-Picture numbers. Sentences initially written with Sound-Writer cards that are then withdrawn are a good challenge for testing decoding and comprehension skill, especially when the writing is read several hours or days later in absence of the Sound-Writer Flashcards and their “tell-tale” Sound-Pictures.

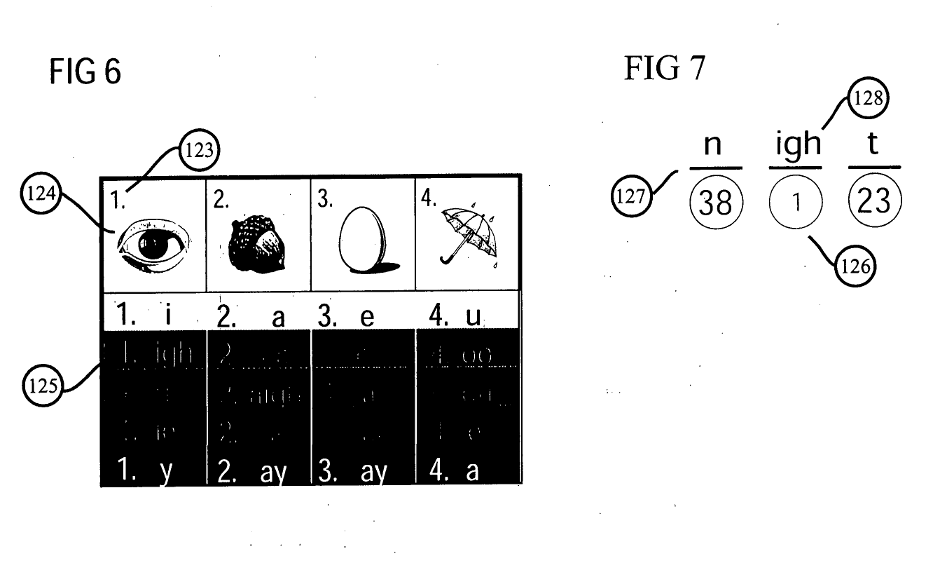

FIG. 6 shows a portion of a Literacy Matrix used with Sound-Picture Numbers 123 to locate a Sound-Spelling correspondence for reading or writing activity. The spellings in the “eye” column such as the “igh” spelling in the green row 125 under the Sound-Picture number “1” identifies the sound as the “eye” sound 124. Thus a specific sound-spelling correspondence is located via a colored Sound-Picture Number such as for a writing or reading activity where for example the circled green Sound-Picture “1” 126 acts as a dual function indicia to locate the sound on the matrix as the #1 “eye” sound and the color green identifies the spelling “igh” down the column of different colors.

FIG. 7 is an activity for use with Literacy Matrix with the spelling 128 having been located and written based on the Literacy Matrix information since the circled Sound Picture number “1” is green. The Matrix Column for Sound Picture #1 has a green row so the sound is spelled “igh.”

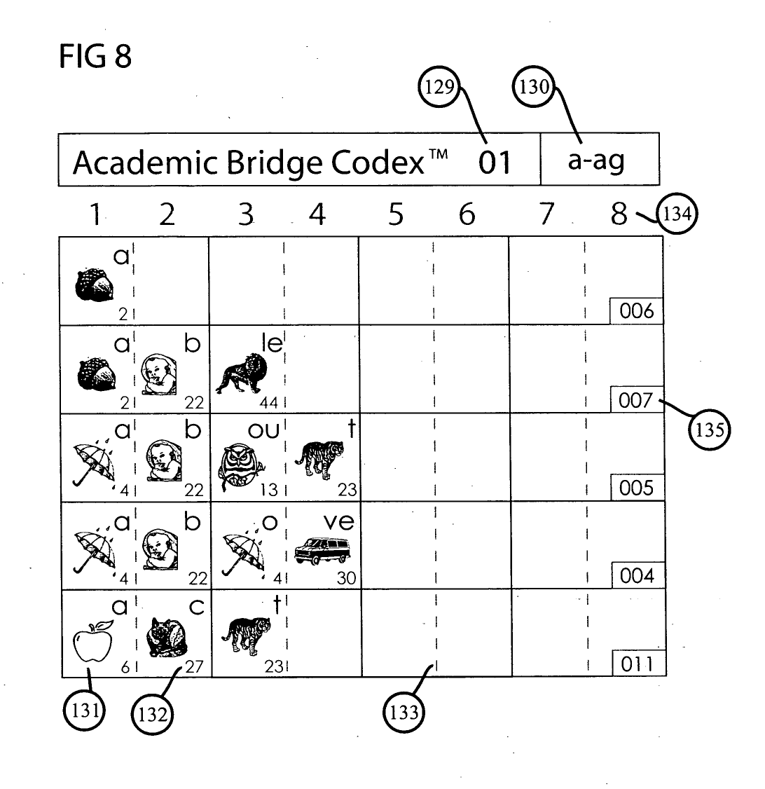

FIG. 8 shows a portion of a page in the Alphabetized/Teacher version of Academic Bridge Codex used by learners or teachers to learn to write from a Writing Codex/Book of the top 1000 words or from a separate and Themed Codex such as one listing occupations, etc. The page number 129 identifies the page and the alphabetic index 130 informs a user the range of words that may be found on the page. The Sound-Picture helps a user identify which sounds 131 are associated with the spelling for each sound in a word. Each Sound Picture 132 number is colored red and may be used to conveniently identify which flashcards or other embodiments (similarly Sound-Picture numerated activity) may be used for other learning instruction for a certain word in the Codex. So a teacher may use the Sound-Picture numbers 4, 22,4, and 30 in an reading or writing activity separate from the either Codex. Vertical dashed lines 133 (not very visible) and solid lines are used to separate and count sounds and may even be modified to separate syllables for easier pronunciation. The number of sounds in a word can be quickly identified with the Number of Sounds Indicator 134. Each word has a unique number 135 that may be used as reference for use in a Codex or separate activity (Coordination with Top 100 Flashcards) and/or may be used to cross-reference a word between the Alphabetized and the Sound-Ordered versions of the Codex so for example, word 007 could be looked up in the Alphabetized version and students would turn to page one of the Sound-Ordered Codex version since there are 10 words on each page and page 1 contains word 007.

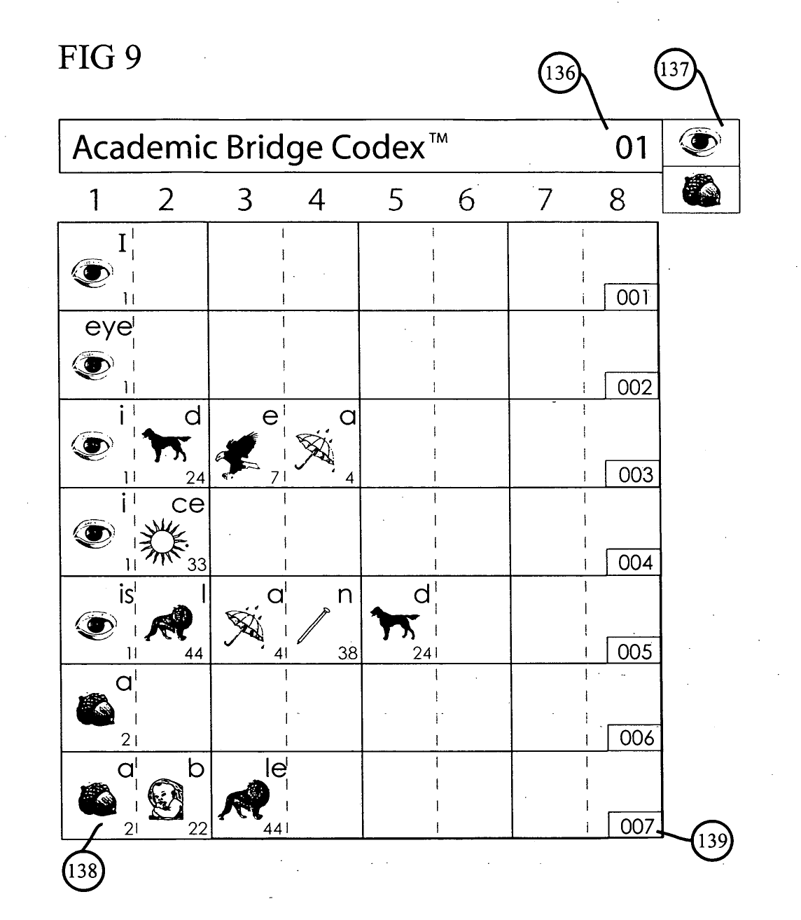

FIG. 9 shows a page in the Sound-Ordered/Learner version of Academic Bridge Codex with the page number 136 shown along with a Sound-Picture Index 137 to let a user quickly identify the range of sounds all the words on the current page begin which would be the “eye” and /ay/ sounds for this page. This is critical since a learner can think of a word they want to write, say for example, “able.” They could use the Codex index of the Sound-Ordered version and find the acorn picture that represents /ay/ on page 1, the first sound in able. They could scan the first column from the left side of the Codex page with acorn 138 Sound-Pictures until they came upon the row with the word “able” by locating the word via blending the next sounds after /ay/ and so on till the combination of sounds makes the word “able.” They will then gain the awareness of the segmented sounds and segmented spellings and associate the corresponding sound-spelling relationships and between the meaning of the word they wanted to write and it's spelling and sound components for reading and writing activity. Eother codex may be modified to further delineate specific words by including a part of speech icon left or right of any entry. For example, a “past tense verb” part of speech icon could be used to identify the past tense word “won” as in, “I won the race.” while a part of speech “noun” icon would differentiate identify the word “one.” The Alphabetized version has a cross reference Word-Number “007” for the word “able” that is used to cross-reference to this similarly numbered “007” Sound-Ordered Codex entry 139.

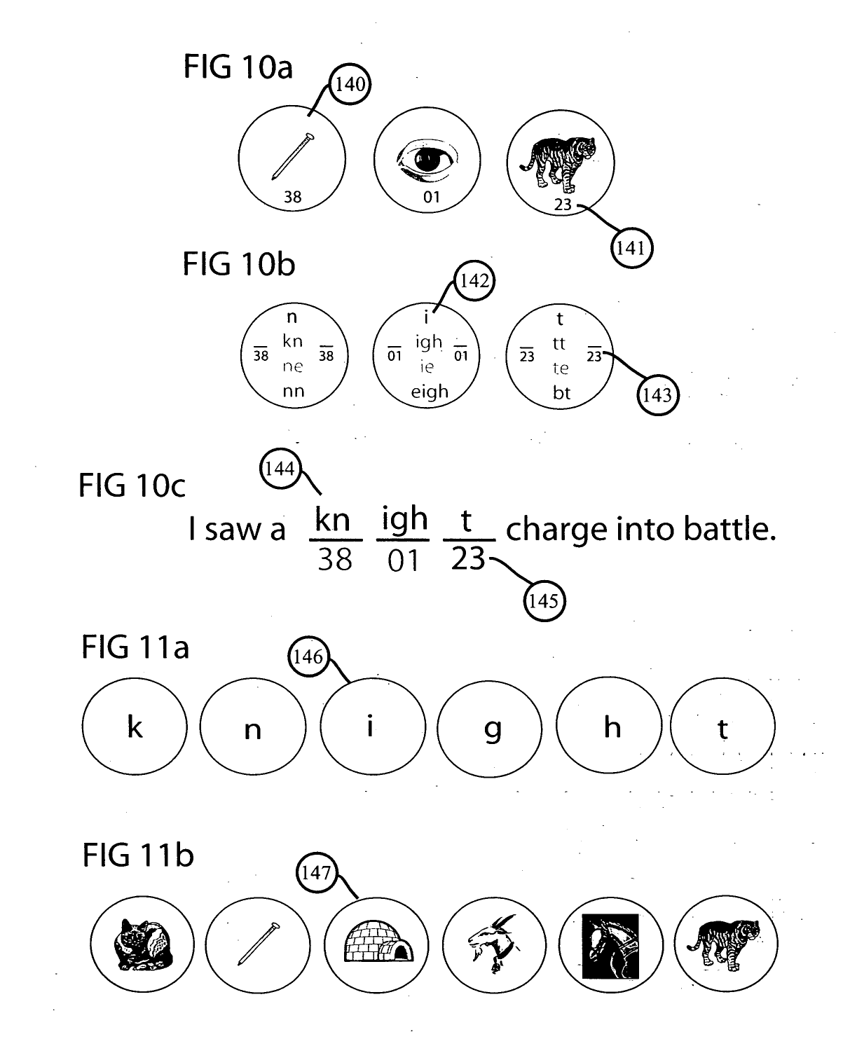

FIG. 10a shows the front side of three Language and Literacy Coins used to teach writing and reading. The Sound-Pictures 140 are on side one each coin with the colored Sound-Picture number for use as dual-function indicia to locate the Coin with the correct Sound-Picture for use in an activity.

FIG. 10b shows the reverse side of three Language and Literacy Coins with alternate colored spellings to aid in selecting a spelling for each sound 142 based on the colored sound picture in a reading/writing activity. A Sound-Picture Number 143 with a line over the number to helps identify/match/use the sound coin for the writing activity line 145 and also to have a standard to orient the coin upright with line above the number just as the writing activity has a spelling line over each Sound-Picture number.

FIG. 10c is an activity useable with Language and Literacy Coins where the word knight has been written from an incomplete sentence. A spelling 144 is written onto each spelling line according to the Colored Sound-Picture Number indicia that helps select the matching colored spelling on the reverse of each coin.

FIG. 11a shows front side of three Phonetic Literacy Coins with a single letter 146 on the front of each coin face that will be used to illustrate the impracticality of teaching a phonetic alphabet that many institutions and individuals practice. Even single multiple-letter spellings will have the same disastrous unhealthy effect.

FIG. 11b shows the reverse side of each Phonetic Literacy Coin of FIG. 11a with Sound-Pictures 147 as the reverse side of the front side of a “phonetic letter” coin to demonstrate a Phonetic Sound-Letter association. For example, the “i” letter coin and the “igloo” coin demonstrates the failure that occurs when the word knight is read/pronounced with the “i” as igloo that is commonly practiced. When each letter is phonetically pronounced, the word “knight” becomes undistinguishable from it's actual 3 sounds /n/i/t/. Both the Non-Phonetic and Phonetic Literacy coins may be used in a software program or educational game to produce the sound when side 1 or 2 is selected and may spin to reveal the highlighted correct spelling(s) for each sound of a word.

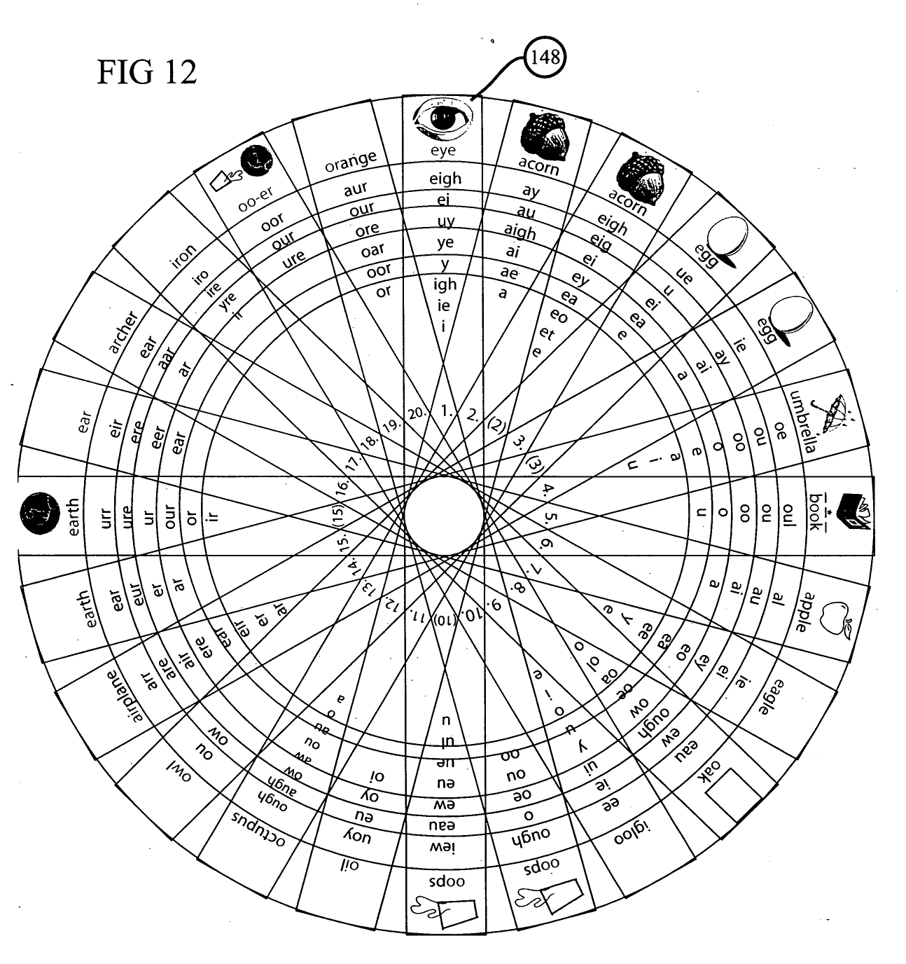

FIG. 12 shows a Literacy Code Wheel of English with a column 148 for each Vowel Sound and contains the associated spellings that may be identified for different words similar to the literacy matrix with the spellings colored to match a colored Sound-Picture Number indicia for example the word night is to be written, the Sound-Picture Number is colored red and the spelling “igh” on the Code Wheel is colored red so I spell the middle sound “igh” as in n-igh-t. The code wheel may be mounted on a spinner and may be used in conjunction with a second non-moving face that would reveal all sound pictures but would have a window to view the spellings via a vertical window for one sound at a time. For example, all the Sound-Pictures with a Sound-Picture number would be visible on the outer rim but different colored spelling in the window could be used to write spellings for a writing activity using colored Sound-Picture numbers.

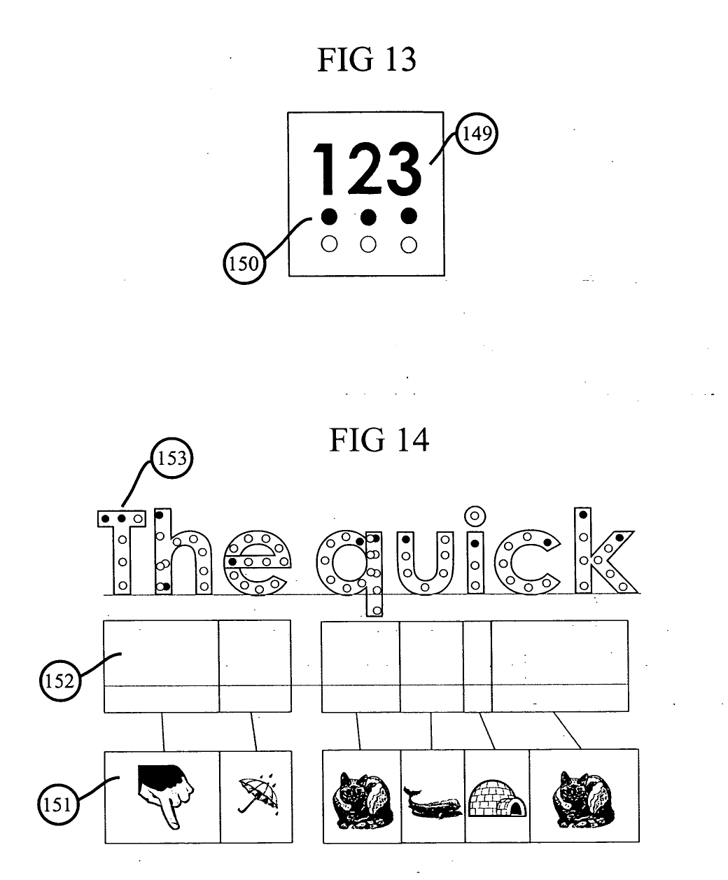

FIG. 13 shows an “Intuitive Stroke Order Indicator” for teaching the order of strokes 149 for an orthography activity for writing the entire alphabet in one sentence (The quick fox jumps over the lazy dog.) The first stroke indicator is a blue number 1 while the last stroke indicator is a blue number 3 (the maximum strokes in all 26 letters is 3). A writer first starts the stroke at the solid dot 150 of stroke 1 then continues to the empty dots until all dots of the same color are filled. Then the next color, green would follow, etc. A dot for the letter “i” would have an empty green circle to be filled. The letter “T” 153 first stroke would begin at the top center of the letter with the solid red dot (since red indicated the first stroke on the stroke order indicator) and would proceed and end at the bottom empty red dot. The second stroke for the letter “T” would start with the upper left filled green dot (since the color green indicates a second stroke for any letter) and this second stroke would proceed to be written towards and ending at the empty green circle dot straight across to the right to complete the second stroke completing the letter. This activity helps learners both accurate and faster write upper and lower case writing since other methods may lead to poorer, slower, and frustrated orthography and frustrated writing in general.

FIG. 14 shows an orthography writing activity for the first two words of the sentence “The quick brown fox jumps over the lazy dog.” First the sound of each Sound-Picture is produced for each word then they are all blended so the meaning of the words is comprehended. Next the meaning and sound codes can be encoded into spellings. The letters are first practiced with the dots then rewritten again in the space 152 provided. Learners practice the correct number and order of strokes for writing letters and learn the spelling and sounds of words while writing the entire alphabet with meaningful words simultaneously in one activity. Other sentences with the entire alphabet may be used for this activity to relieve repetitiveness.

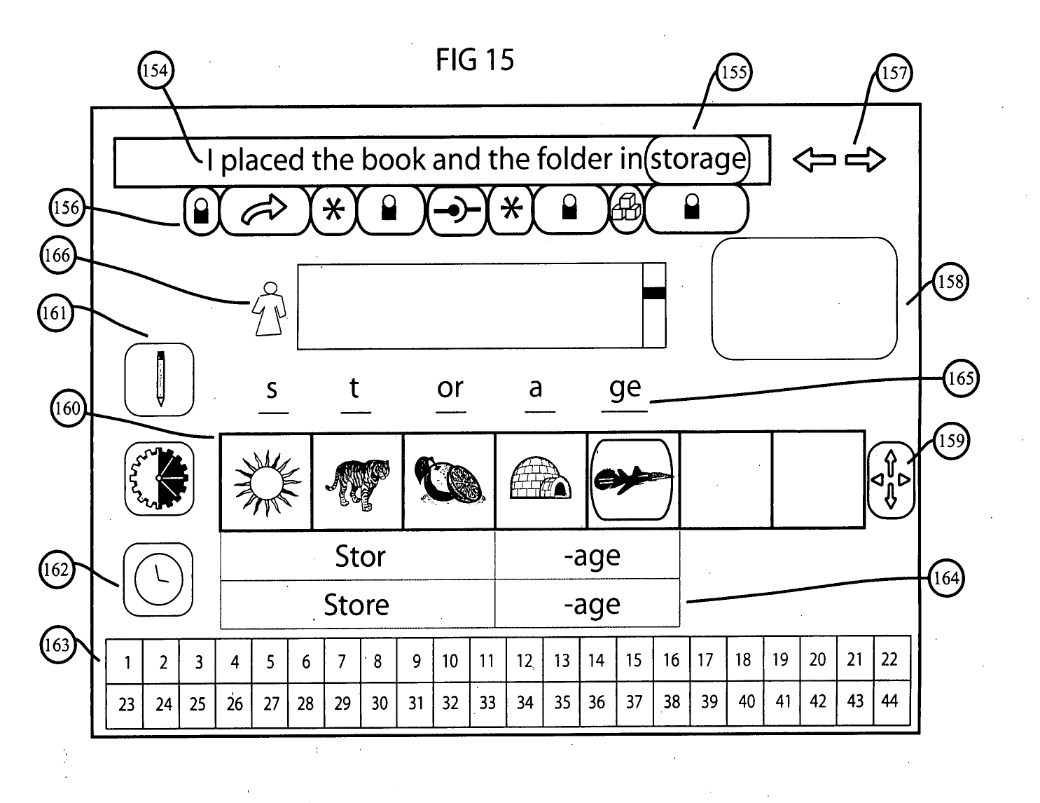

FIG. 15 shows a screen shot of the Blue Tiger Literacy Software program. The text area 154 shows a sentence being examined and the word “storage” 155 being focused on which may be changed by using the left/right arrows 157. Under the text area Part of Speech Icons 156 help a learner identify and learn the functional mechanics of word classes and how Word Classes reflect the meaning and interactions between words. A window 158 is reserved for any video or illustration to be used for semantic cueing or enhancement in learning word meanings such as an illustration of a book when the noun class word “book” is focused on. The focus area 160 has arrows buttons 159 for which sound from the sound pictures of the word “storage” is highlighted. Clicking the jet Sound-Picture will produce the sound /j/ while the spelling “ge” becomes temporarily highlighted. There are three icons 161 in the left center of the screen. The pencil button is used to have the program write the word from scratch (it will remove all the spellings then trace each letter on each spelling line. When the gear icon is pressed on the light side, the whole word will be produced as if read/spoken blended. When the dark segmented part of the icon gear is clicked, it will produce each sound by sound while highlighting each spelling as each sound is produced. The last clock icon 162 can be used for past tense verbs to indicate if a verb is past tense (9 o'clock arrow position), present tense (12 o'clock arrow position), future tense (3 o'clock arrow position), etc. The bottom of the screen displays all 44 Sound-Pictures for use in quizzing activities or word-searching activity similar to Sound-Ordered Codex where so that a Sound-Picture may be clicked on to sort through words by sound by sound in which case the reserved window 158 may be used to identify which word is being selected since some words have the same sounds but different spellings and meanings (eg. Select between Knight and Night so it is spelled correctly in the focus area 160). Another feature is the word origin and syllable identifier window 164 that shows the morphemes and syllables for the focus word 165. Lastly, an icon 166 representing a assistant called Socrates is a sub-program to help learners use Blue Tiger including having him pronounce words with detail of mouth movements for a word by dragging him onto the reserved window 158. Each Sound-Picture and it's spelling will be highlighted as he produces each sound and he will next blend the word as a whole spoken word while the entire spelling and all the Sound-Pictures are highlighted.

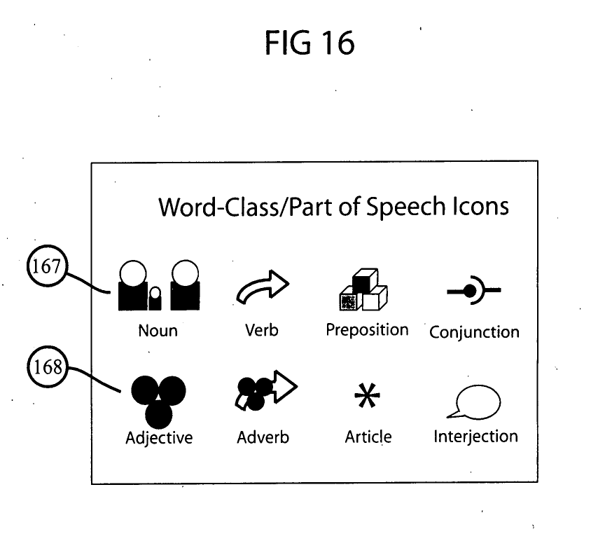

FIG. 16 shows a legend for icons representing Parts of Speech used in Blue Tiger, Flashcards and other embodiments. The Icons including 167, 168 are each listed with the Part of Speech/Word Class they represent.

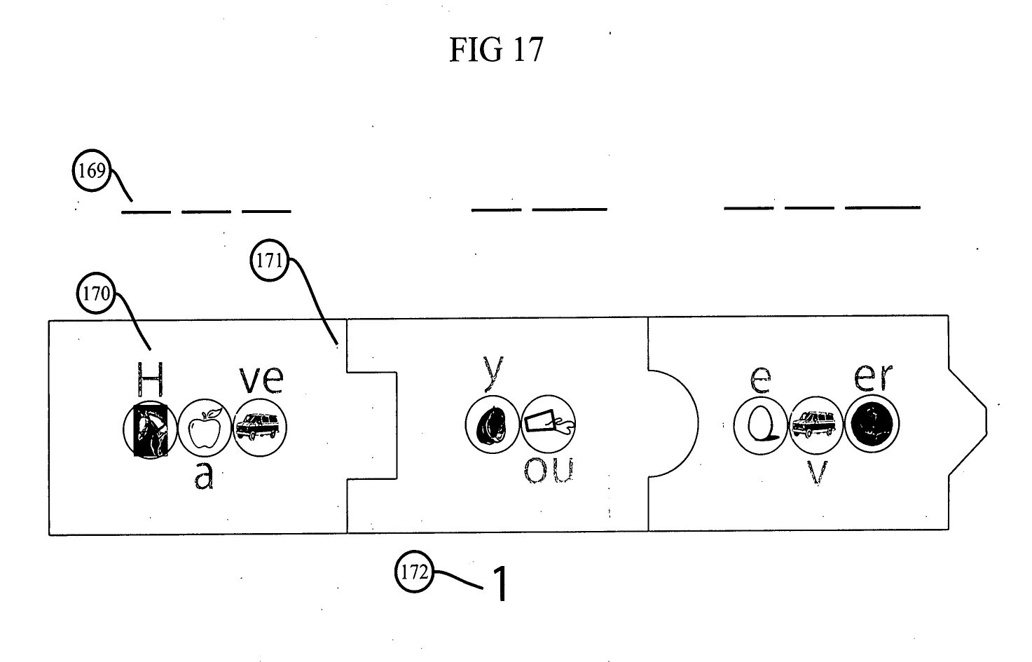

FIG. 17 shows page 1 172 from a “Write it Yourself” book including a writing activity and three connectible Grammatical puzzle pieces that are first connected by their compatible edges 171 face up, then the Sound-Pictures 170 are used to produce sounds and identify the spelling used to represent the sound where the spellings are then written on spelling lines 169. The pieces are compatible as they are grammatically compatible with the possibility of changing some of the pieces. For example, the noun “you” piece can be exchanged with a similarly shaped noun “we” piece.

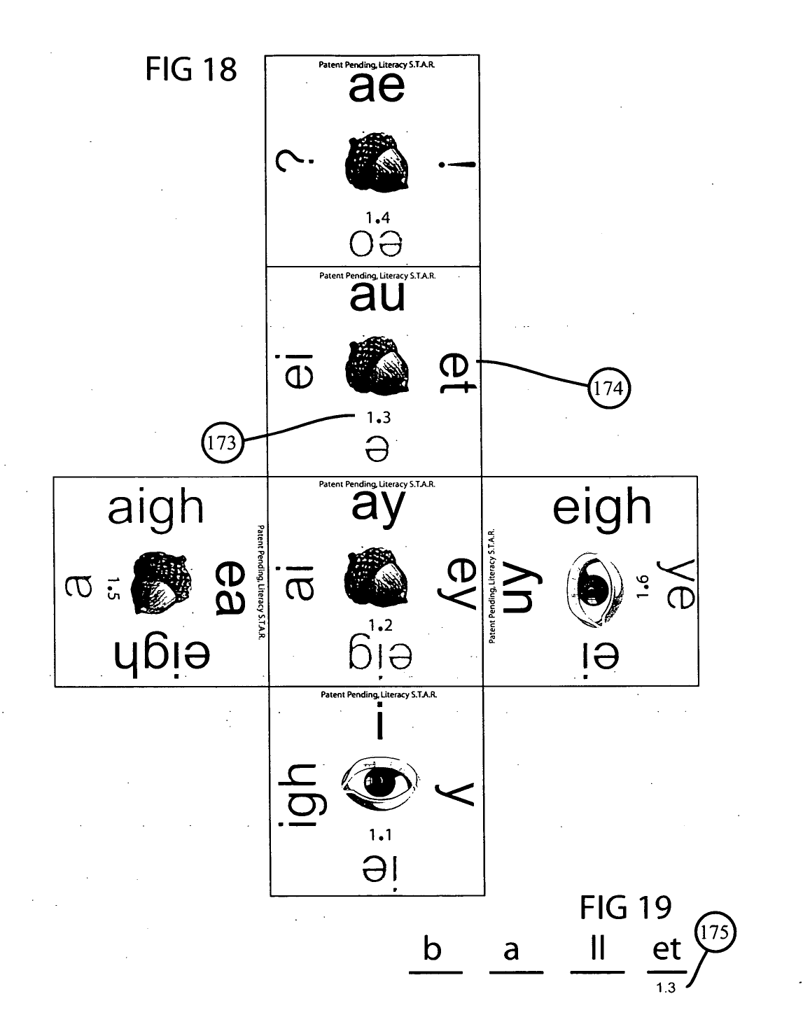

FIG. 18 shows a Graphophonic Block where the decimal reference number 173 is black while the spellings 174 are colored differently and match with a dual-function Decimal Reference indicia number that is colored in a writing activity to locate the block, then the face of a block, and finally the color of the writing activity Decimal Reference indicia matches with and identifies the similarly colored spelling on the block to locate the spelling for a sound in writing activity.

FIG. 19 shows an activity for FIG. 18 where a decimal reference number 175 acts as an indicia to select block 1, side 3 (1.3 173) and to use the red colored spelling 174 to spell the sound /ay/ as “et” for the word ballet.

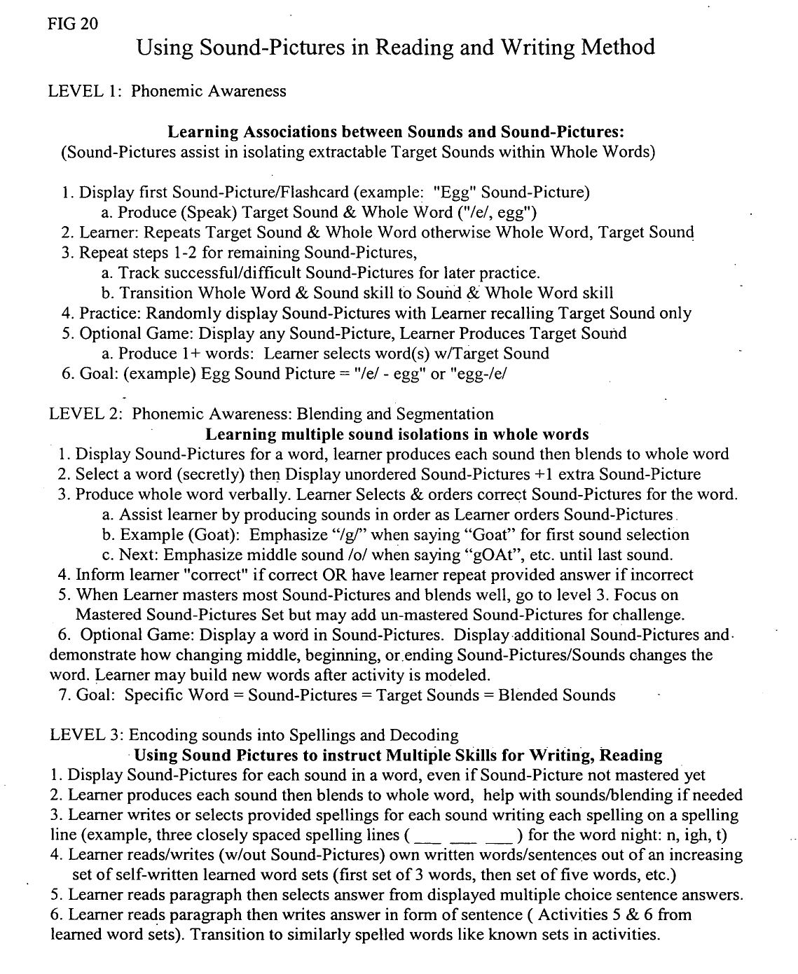

FIG. 20 shows details on How to Use Sound-Pictures in Reading and Writing activities for embodiments of invention

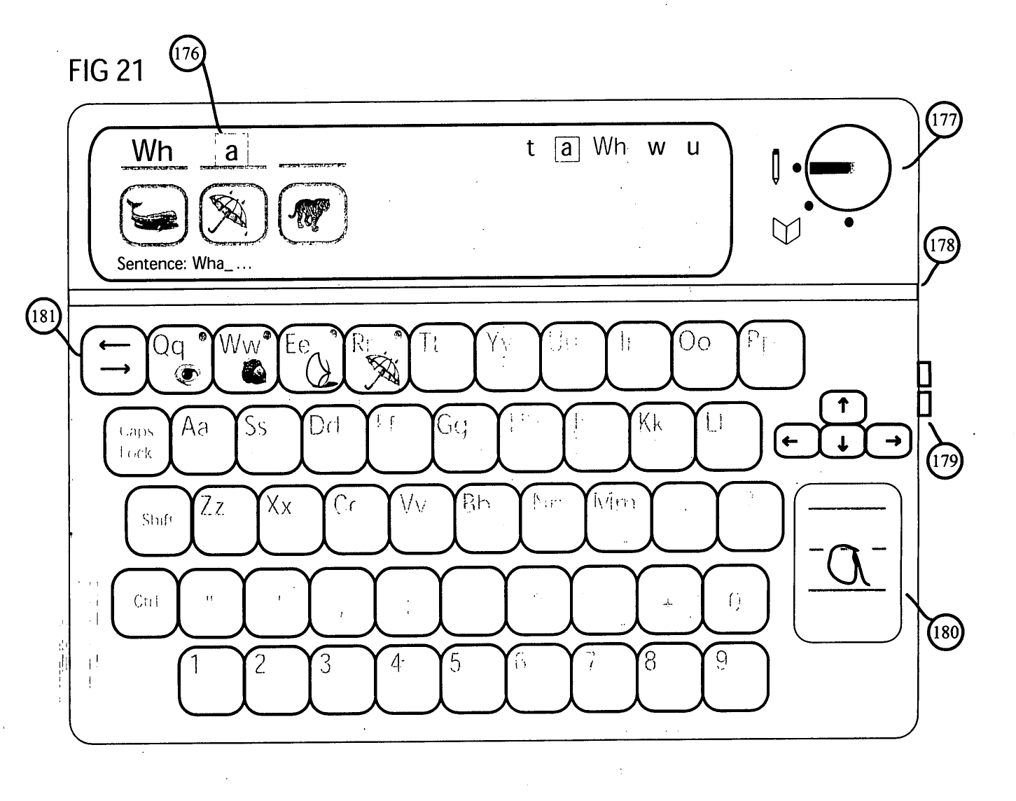

FIG. 21 shows a Reading and Writing Proprietary Device. The activity screen 176 area will be used for Phonemic Awareness, reading, and writing activities using Sound-Pictures and spellings displayed on the activity screen from activity databases or use the Sound-Picture and letter buttons 181 to select sounds or letters. The Activity Selector Switch 177 includes activities (pencil), writing (book icon) reading and (shell) practicing identifying, associating, blending, and segmenting sounds using the Sound-Pictures on the activity screen and for example by pressing the Sound-Picture buttons when a sound is produced to practice associating Sound-Pictures to their respective Target Sounds. The top section which has the screen may be angled toward the user for better viewing 178 with the swivel action. There are two jacks 179 for a headphone set and a microphone for voice recognition activity. A writing pad 180 is located on the right hand side and may be located on the left side for left-handed writers.

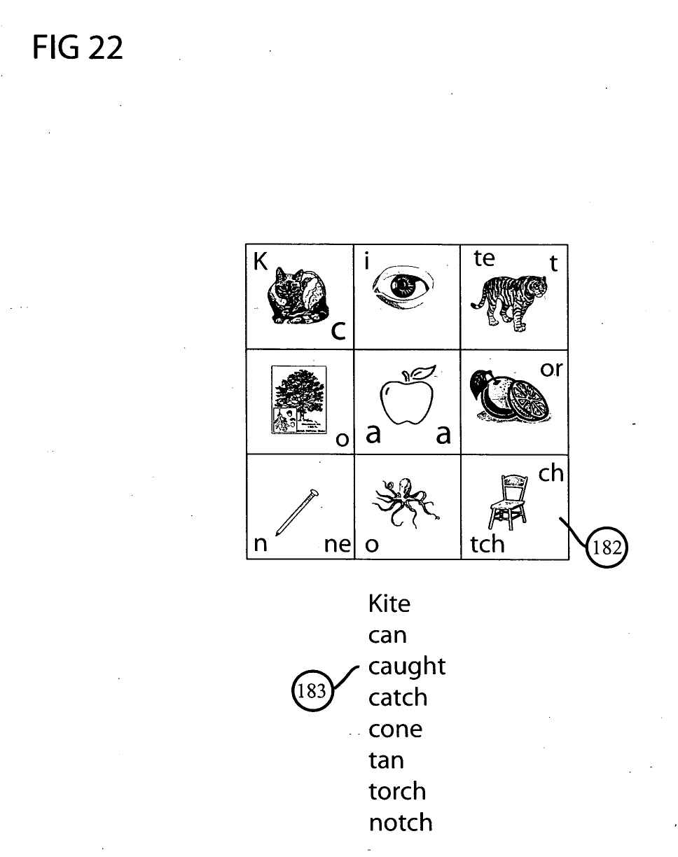

FIG. 22 shows a Phonemic Awareness and Literacy Bingo Game with each bingo square 182 containing a Sound-Picture surrounded by spellings. Listed are all the words 183 contained within the puzzle. The spellings are intuitively placed in each corner to correspond with

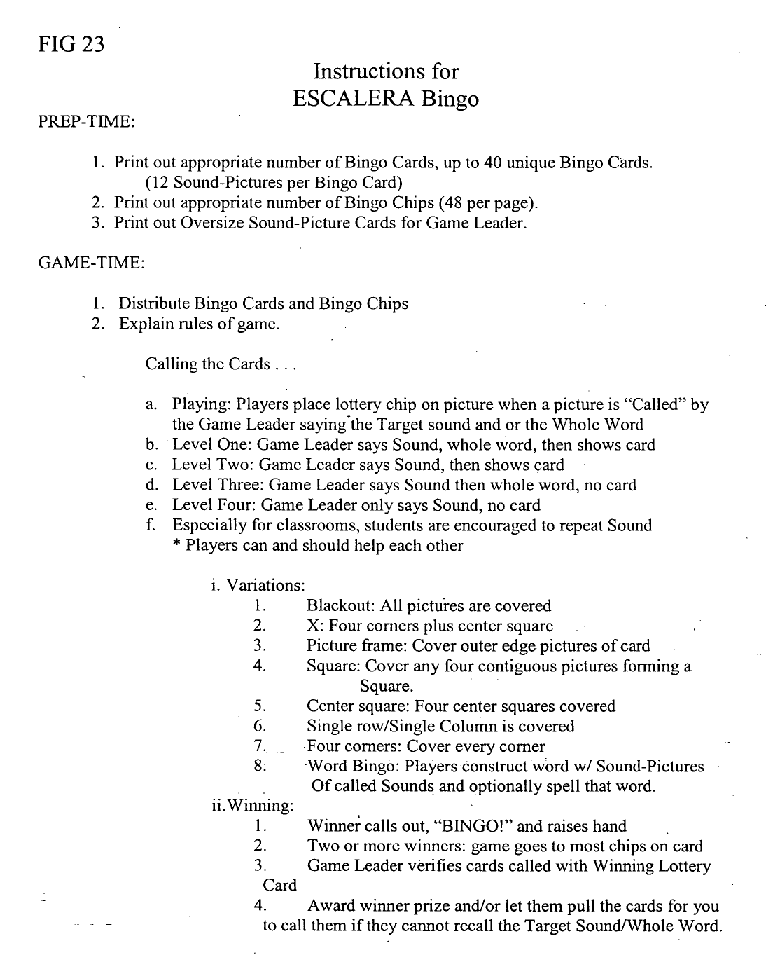

FIG. 23 shows instructions for ESCALERA Bingo for home or classroom use.

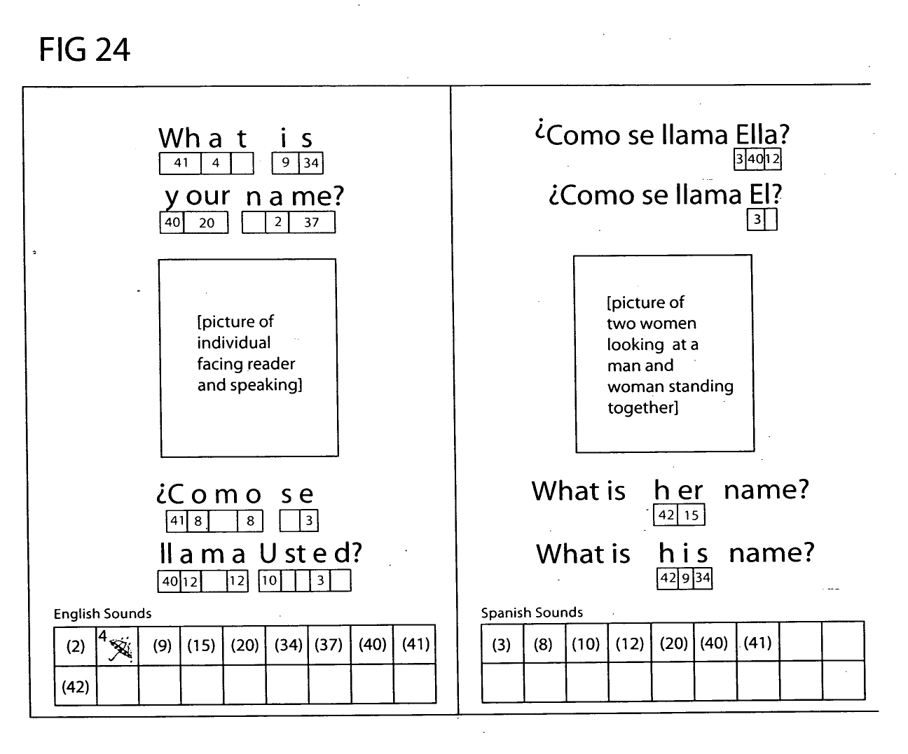

FIG. 24 shows two pages of a Language Learning Book with Spanish and English material. A spelling line under each spelling identifies the letter(s) associated with a single sound and the Sound-Picture number under each spelling line can be used to locate the corresponding numbered Sound-Picture located at the bottom of each page for aide in determining the sound of a particular spelling. The Sound Picture number “4” which is the umbrella picture is shown as an example. The separation of the Sound-Picture from the text is an advantage in that there is a degree of separation so the learner is forced to challenge their recall of the letter “a” with the schwa sound of the umbrella Sound-Picture. Also the learner may memorize the Sound-Picture number “4” for its schwa sound which is also an advantage so as to not rely on the Sound-Picture and to also not associate the umbrella Sound-Picture with the letter “u.”

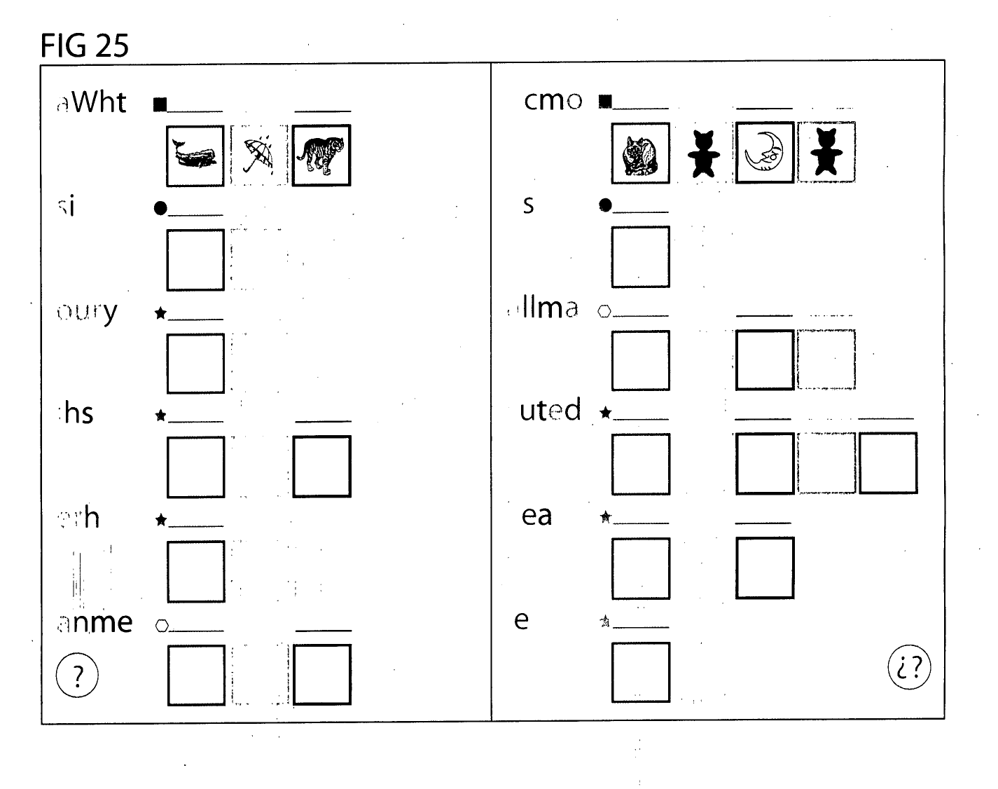

FIG. 25 shows two pages of a color-coordinated Writing Language Book. Each page has a conversational phrase in either English or Spanish. Each word may be written on the spelling lines (one spelling at a time for each sound) above the Sound-Pictures. The Target Sounds of each Sound-Picture can be first sounded out then verbally blended together to form the whole word. This activity clearly demonstrates the segmented nature of language as spellings and sounds that merge or blend together to become quite confusing for novices without assistance such as this activity. The spellings for each word are unordered at the left of each page and each spelling is colored a certain color to match with both the spelling line above a sound picture so that a green-colored spelling goes on the green line above the green box. For example, the word in the upper left is “what.” The spelling line above the whale Sound-Picture and the box is colored green like the spelling “wh” that cues a user to write “wh” for the first sound of the word “what” and repeating same steps for each matching set of colored spellings, lines, and boxes would lead one to write the word completely. The solid or empty shapes (square, circle, star, and hexagon) next to the left of each word show a learner which words to use to vary the sentence. For example, a learner could read or say, “What is your/his/her name.” The learner can choose to say up to three different sentences since there are 3 variable subjects indicated by three solid stars, “What is your name?” or “What is his name?” or “What is her name?” The solid star being next to each subject alerts the learner they may select on of the words to speak, read, or write.

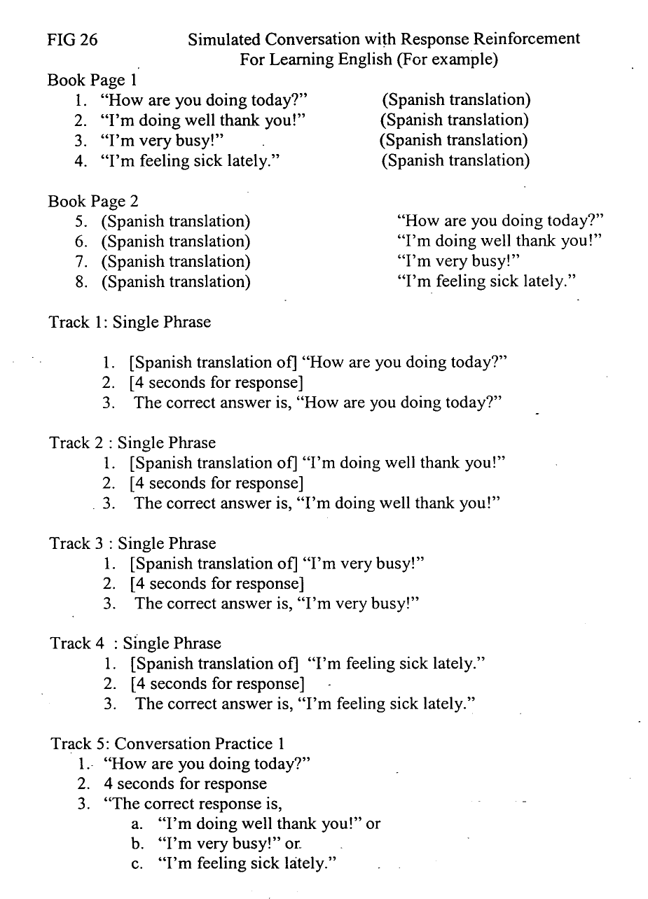

FIG. 26 is a method for simulating conversation to learn a second or foreign language or to learn any material involving recall or verbal response. The method may be used with a book and Compact Disc player or ideally with an Mp3 player or computer audio program like Winamp or Windows Media Player. Book pages 1 and 2 show phrases that will be practiced on the audio player/device. Tracks 1-4 are single phrases that can be practiced (track 1 for example) by first hearing the phrase in one's native language to cue the learner to recall the target language phrase that was practiced with the book. The track then gives a 4 second pause for the learner to recall and verbally recite the same phrase except in English (the target language in track 1 for example). This will allow learners to use their native knowledge/language and individual mind to know what meaning they want to or need to speak in English. Finally, track one informs the learner if they are correct (reinforcing their learning) or if they are incorrect. An incorrect attempt would prompt the user to practice with the book or repeat the track by hitting a back or repeat button on the audio device. Track 5 is a simulated conversation track where a learner may respond with several phrases. Optionally, a track may tell a learner in their native language which response to recall and recite. For example, Track 5 could be adjusted to tell the Spanish learner they are feeling sick in their native language, then it could query them with the English question, “how are you feeling?” This will force learners to learn all responses. This method allows Mp3 users to add new tracks they'd like to learn and remove tracks they have mastered to eliminate redundancy. Tracks can be numbered 5a, 5b, 5c if all the tracks are related to a certain theme such as meeting someone. Finally, the random function on the audio device can be set to random so that a learner will have to respond in real time to a speaker by the unpredictability of tracks playing randomly. This will give learners a chance to practice a great amount of vocabulary, phrases, and master certain conversational themes quickly with the confidence of knowing whether they responded correctly or not. They may also compare their pronunciation from the audio track speaker and use the book with Sound-Pictures to practice particular words or sounds that are challenging. Tracks may also contain the Sounds and Sound-Pictures for a language along with some verbal blending and segmentation exercises in the same manner as the conversational response format where a learner is cued to blend or segment a word, 4 seconds are allowed, then the answer is provided, etc.

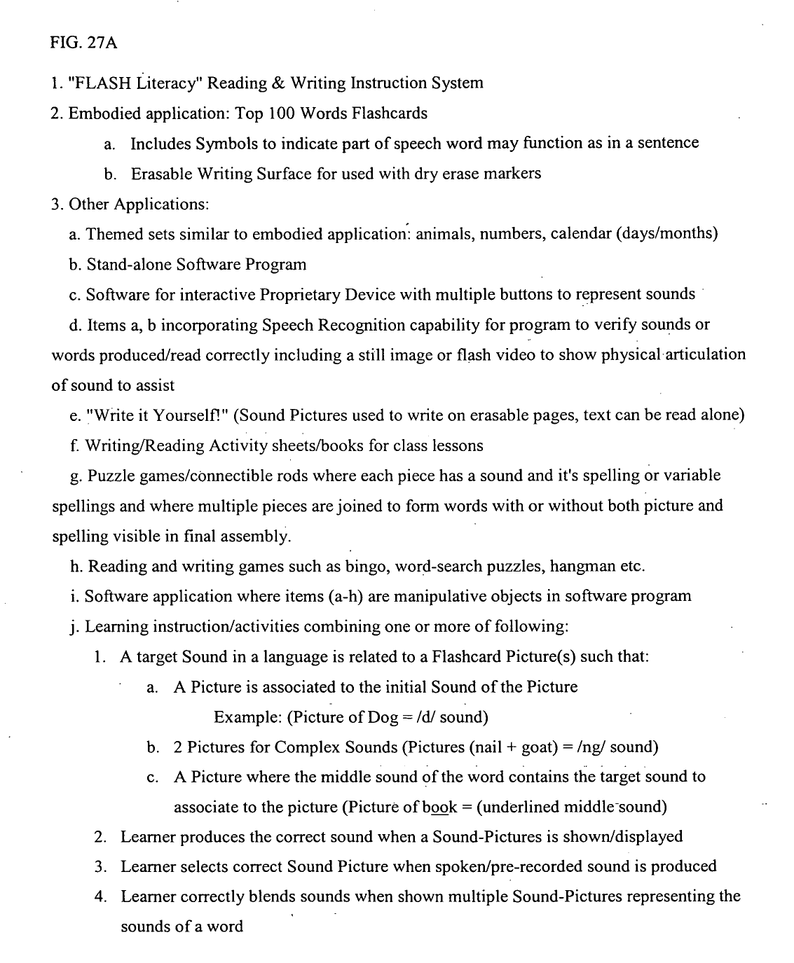

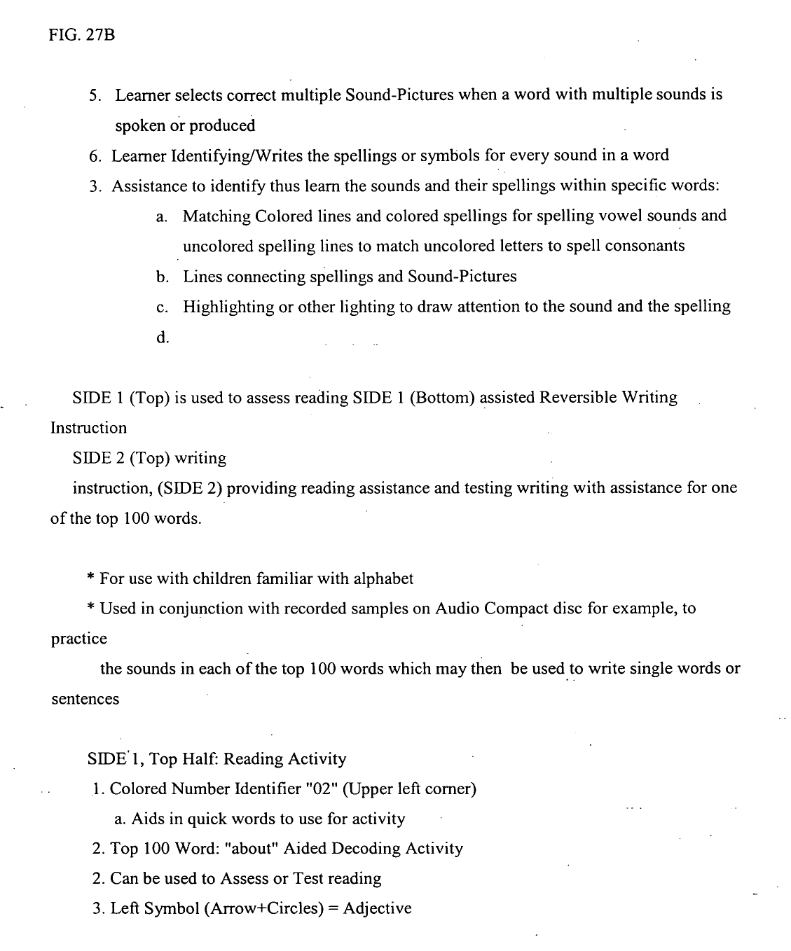

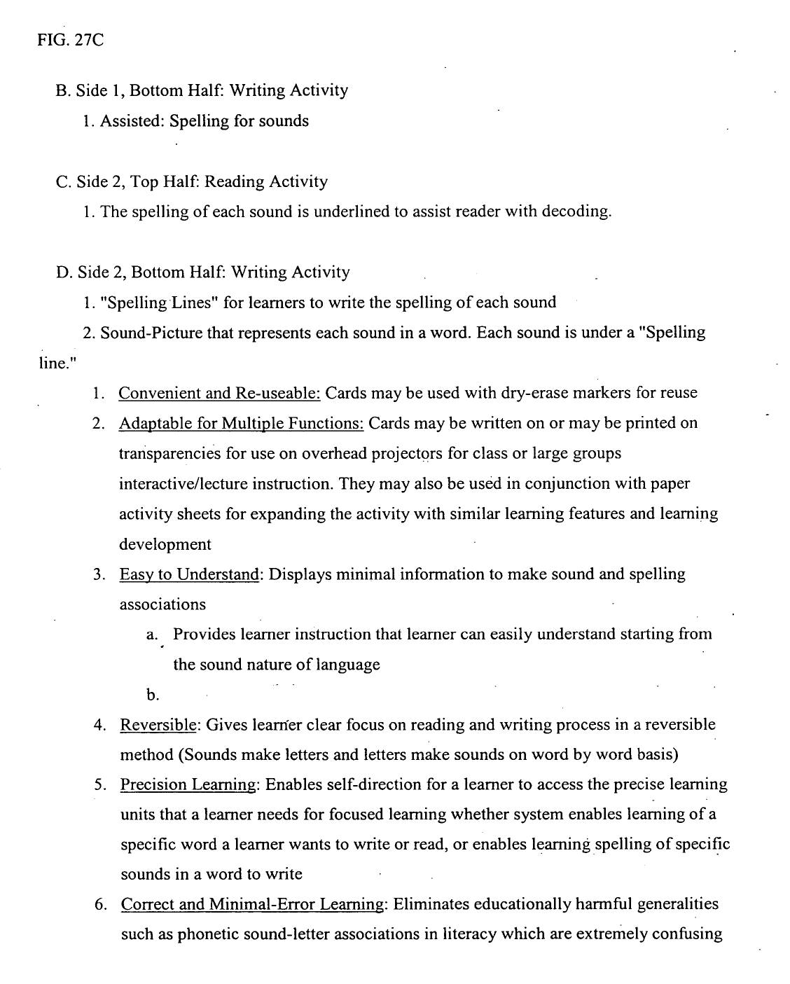

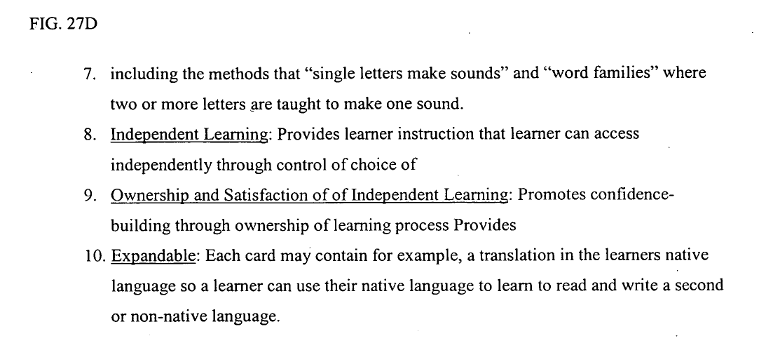

FIG. 27A-D shows further description of Flash Literacy Cards.

The invention can be found in several different embodiments. Example embodiments include the following:
1. A method to Associate Target Sounds to Sound-Pictures for later activity in reading, writing, and pronunciation assistance so that displaying the Sound-Picture will recall into memory the Target Sound for any activity with or without verbally producing the Target Sound.
2. A method to teach reversible writing by displaying a Sound-Picture then having the learner produce the Target-Sound or automatically producing the sound first teaching writing so that a learner is given direction, instruction and/or uses two indicia or a dual-function indicia (colored number) to associate the sounds and spellings of any given word so that a learner:
   a. writes a word they can't read yet with sounds visualized as Sound-Pictures
   b. learns to write a word they can read but cannot write well
   c. is tested on words to read or write they have been instructed to write with system
3. A method of displaying the exact to approximate sounds in a spoken word and their corresponding spellings by clearly delineating sound-letter correspondences in writing activity where specific sounds are represented by Sound-Pictures and spelling associations are instructed including for unique meanings whether the sounds or spellings are the same but the meaning or sounds are different (reed vs. read) and (read vs. red)
4. A method to maximize learning for reading, writing, comprehension, listening and speaking skills by maximizing comprehension and no-error learning by utilizing and/or associating or more of the following in activities:
   a. produced Sounds of a language including Sound-Pictures to represent them
   b. writing/selecting spellings as the symbols/letters used to represent the sounds in conjunction with the Sound-Pictures
   c. direction for a learner to read their own written words at a later time
   d. semantic cues such as videos, illustrations, analogies
   e. symbols to represent part of speech for words in a sentence
   f. utilizing native or second language (spoken or written words) to migrate meaning association to learning a new target language
5. A method of instruction or direction to guide a learner to use the associated Target Sound of a Sound-Picture to locate a word they want to write, then to display the sound-spelling associations in segmented form demonstrated by Sound Pictures with the spelling of each sound proximate to each Sound-Picture for the learner to write the word and become fully aware of each and every sound and spelling association. (Academic Bridge Codex)
6. An automated display of Sound-Pictures for a word and simultaneous automated production of the associated sounds as a Sound-Picture and/or highlighting the spelling of a sound for a word that is being written
7. A direction or instruction to guide a learner to first focus on listening and/or producing the sounds of a word they are to then spell by selecting spellings from a list of alternate spellings for each sound or to select/order spellings for a word: example (igh, n, t) night
8. Instruction or Indicia to correspond a Sound-Picture and a sound to a spelling by one or more of the following:
   a. Proximity between Sound-Pictures and associated spellings
   b. Software Automatically Produces the sound when the Sound-Picture is selected
   c. Software Highlights one or both of the Sound-Picture and spelling
   d. A Spelling Line colored to match and identify correct spelling, similarly colored
   e. A Sound-Picture Number colored to match and identify a correct spelling that is similarly colored along with primarily identifying the Sound-Picture by number.
   f. A colored indicia such as decimal reference number that identifies a sound by the number and identifies the correct spelling from a set of alternate spellings by matching colors between the number and one of the different colored spellings.
9. Instruction to understand or automated demonstration of non-logical (non one-to-one) alphabetic sound and spelling correspondences including:
   a. the production of one, more than one, or all sound(s) for a word
   b. the display of sound pictures involved for the spelling and whole word
   c. the display of letter(s) involved in the spelling or the whole word.
   d. different words containing similar spellings with different sounds
   e. different words containing similar sounds with different spellings
   f. sounds that are unspelled such as the first sound of the word “one” /w/u/n/
   g. spellings that have more than one sound
10. A dual function indicia or two indicia with two functions or an instruction that informs a learner of the Sound of spellings or the spellings of sounds within a word including by single or combined methods of:
   a. highlighting, underlining, or focusing attention to delineate which letter(s) the spelling correspond with which sound consists in coordination with a proximate display or concealed of a Sound-Picture,
   b. automated production or the activation of a production of a Target Sound of a Sound-Picture near a spelling or
   c. activating a target sound before a previously undisplayed spelling is revealed near a Sound-Picture or Sound-Picture number.
   d. passing over with a mouse pointer, contacting, or clicking a pointer or pen-object over or onto a Sound-Picture or a button
11. An instruction to select words that have similar or different, beginning, middle, ending sounds including a display of Sound-Pictures to assist in delineating those similarities or differences.
12. A game where Sound-Pictures and or their spellings line-up or match up to produce a word like a slot machine, or a bingo game, or a lottery ticket which in the case of the slot machine or electronic device may produce the single sounds and/or blend the sounds to produce the whole word.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
providing a plurality of character sets, such that the character sets in the proper order spell a word in a given language, each character set being associated with a unique color relative to the other character sets in the plurality; and
providing a set of items representing character locations, such that each item is associated with an image representing the sound of one of the character sets and a color matching the color associated with the one of the character sets;
wherein the colors associated with the items representing the character locations indicate the order of the character sets to spell the word.

2. The method of claim 1, wherein each item includes a line.

3. The method of claim 1, wherein each item includes a box.

4. The method of claim 1, wherein the image represents an thing recognizable by a person learning to read and write, and wherein the image begins with the sound of the character set associated with it.

5. The method of claim 1, further comprising the step of providing the word visibly to the reader while they are attempting to arrange the character sets in the proper order.

6. A device for assisting a person to learn to read and write, the device comprising:
a first medium for presenting a plurality of character sets, such that the character sets in the proper order spell a word in a given language, each character set being associated with a unique color relative to the other character sets in the plurality; and
a second medium for presenting a set of items representing character locations, such that each item is associated with an image representing the sound of one of the character sets and a color matching the color associated with the one of the character sets;
wherein the colors associated with the items representing the character locations indicate the order of the character sets to spell the word.

7. The device of claim 6, wherein the first and second mediums are on a single flashcard.

8. The device of claim 6, wherein the device is made for use with a dry erase marker.

9. The device of claim 6 wherein each item includes a line.

10. The device of claim 6, wherein each item includes a box.

11. The device of claim 6, wherein the image represents a thing recognizable by a person learning to read and write, and wherein the image begins with the sound of the character set associated with it.

12. The device of claim 6, further comprising a medium for presenting the word visibly to the reader while they are attempting to arrange the character sets in the proper order.
